(19) United States
(12) Patent Application Publication
(10) Pub. No.: US 2009/0016044 A1
(43) Pub. Date: Jan. 15, 2009

(54) INTEGRATED DC CIRCUIT FOR A CEILING FAN COMBINED WITH A LAMP

(76) Inventor: Mei-Han LI, Taichung City (TW)

Correspondence Address: SINORICA, LLC, 528 FALLSGROVE DRIVE, ROCKVILLE, MD, 20850, US

(21) Appl. No.: 11/776,629

(22) Filed: Jul. 12, 2007

(51) Int. Cl. F21V 29/02; H02H 5/04; H02H 7/09; H02P 7/08; H05B 41/36

(52) U.S. Cl. 362/96; 315/272; 361/24; 361/30

(57) ABSTRACT

An integrated DC circuit for a ceiling fan combined with a lamp is composed of a control circuit connected with a motor and a lamp, and a rectifying-filtering circuit connected with the control circuit. The rectifying-filtering circuit can alter an exterior AC power into a DC power for the motor and the lamp to use. As the motor and the lamp use the same DC power, electric leakage can be minimized to upgrade security and only a simplified structure with less material is needed, posing a reduction of cost.

### BACKGROUND OF THE INVENTION

1. Field of the invention

This invention relates to a control circuit, particularly to one with an integrated DC circuit employed for a ceiling fan combined with a lamp.

2. Description of the Prior Art

Commonly, a conventional ceiling fan is used not only to cool down an indoor temperature, but also as a decoration. Moreover, in recent years, the conventional ceiling fan combined with a lamp has almost been becoming a necessary appliance in a family. Such a ceiling fan-lamp is provided with a motor installed with a control circuit that can receive signals transmitted from a fan control switch for controlling blades to rotate rapidly or slowly, and another control circuit used to receive signals transmitted from a lamp control switch for controlling the brightness of the lamp.

If a low-power and low-noise DC brushless motor is to be used, the AC power commonly supplied has to be altered into DC power by a converter. However, the lamp usually needs AC power that is different from what the DC brushless motor needs. Therefore, such a conventional ceiling fan-lamp must be installed with two different power systems, having a complicated installation to cause a high cost. And, most of the conventional lamp uses only compatible lights, restricting the use of diverse types of lights and consuming too much energy. Moreover, different voltages used simultaneously may easily cause electric leakage.

### SUMMARY OF THE INVENTION

The objective of this invention is to offer an integrated DC circuit for a ceiling fan combined with a lamp.

The main characteristics of the invention are a rectifying-filtering circuit and a control circuit. The control circuit has its one end connected with the rectifying-filtering circuit and another end connected with a motor and a lamp respectively, provided with a control signal receiving unit for receiving control signals transmitted by a control module set outside the lamp, and a microcomputer unit employed to receive, process, analyze and code the control signals transmitted from the control signal receiving unit. The microcomputer unit is connected with the rectifying-filtering circuit to transmit a power to a first driving loop to activate the motor and a second driving loop to activate the lamp.

With the rectifying-filtering circuit, an exterior AC power can be altered into DC power for the motor and the lamp to use. As the motor and the lamp use the same DC power, electric leakage can be minimized to upgrade security and only a simplified structure with less material is needed, obtaining a reduction of cost.

### BRIEF DESCRIPTION OF DRAWINGS

This invention is better understood by referring to the accompanying drawings, wherein:

FIG. 1 is a block diagram of a first preferred embodiment of an integrated DC circuit for a ceiling fan combined with a lamp in the present invention; and

FIG. 2 is a block diagram of a second preferred embodiment of an integrated DC circuit for a ceiling fan combined with a lamp in the present invention.

### DETAILED DESCRIPTION OF THE PREFERRED EMBODIMENT

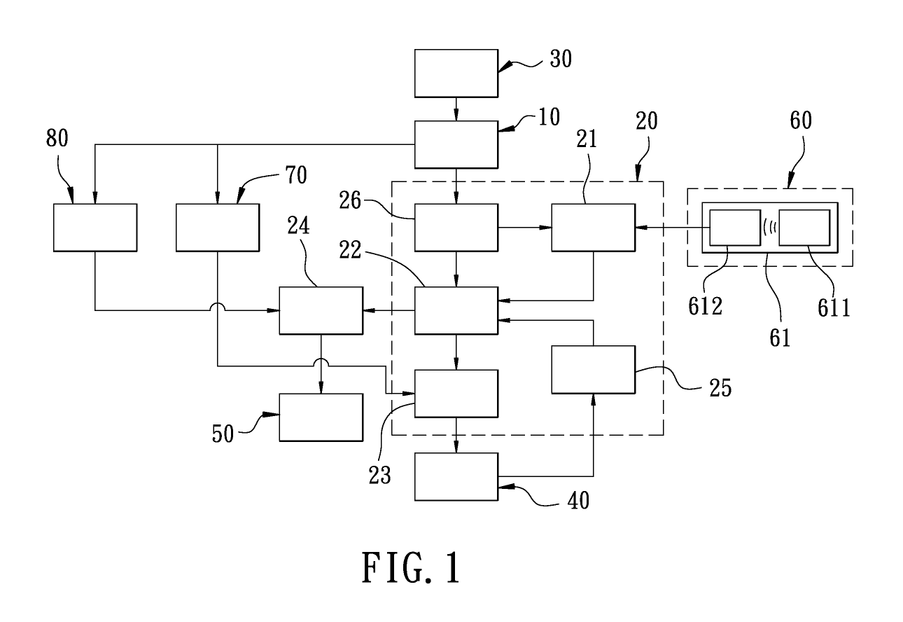

FIG. 1 is a circuit block diagram of a first preferred embodiment of an integrated DC circuit for a ceiling fan combined with a lamp. The integrated DC circuit is properly installed inside the shell of the lamp, provided with a rectifying-filtering circuit 10 and a control circuit 20.

The rectifier-filter circuit 10 is connected with an exterior power source, employed to alter exterior AC power into DC power.

The control circuit 20 has its one end connected with the rectifying-filtering circuit 10 and another end connected with a motor 40 and a lamp 50 respectively. The motor 40 is a DC brushless motor, and the lamp 50 can be a commercial light, such as LED. The control circuit 20 is provided with a control signal receiving unit 21 used to receive control signals transmitted by a control module 60 set outside the lamp 50. The control module 60 is provided with a wireless control unit 61, which corresponds to the control signal-receiving unit 21, provided with a wireless emitter 611 and a wireless receiver 612. The wireless receiver 612 can receive wireless control signals sent from the wireless emitter 611, and then transmit them orderly to the control signal receiving unit 21 and a microcomputer control unit 22 for calculating, analyzing and coding. The microcomputer control unit 22 is connected with a Hall element 25 that can feedback an induced signal of the detected displacement of a magnetic element of the DC brushless motor 40 to the microcomputer control unit 22. The microcomputer control unit 22 is also connected with the rectifying-filtering circuit 10 to transmit power to a first driving loop 23 connected with the microcomputer control unit 22, so as to activate the motor 40 connected with the first driving loop 23. The microcomputer control unit 22 is in addition connected with a second driving loop 24 to supply power for the lamp 50 that is connected with the second driving loop 24. As the power supplied by the second driving loop 24 is a low-voltage DC power, the lamp 50 can be provided with all kinds of commercial lights. Furthermore, the first driving loop 23 and the second driving loop 24 are respectively connected with a first manual pulling switch 70 and a second manual pulling switch 80, which are also connected with the rectifying-filtering circuit 10. Via the rectifying-filtering circuit 10, power is transmitted to the first driving loop 23 to drive the motor 40 and the second driving loop 24 to light up the lamp 50. Therefore, a power-protecting unit 26 is connected between the microcomputer control unit 22 and the rectifying-filtering circuit 10 to prevent the control circuit 20 from damaged by over-voltage, over-current and over-heat.

In assembling, the rectifier-filter circuit 10 is connected with the motor 40 and the lamp 50 to supply DC power to them. The wireless control unit 61 of the control module 60 is to control the motor 40 and the lamp 50 to work. The wireless receiver 612 is properly positioned inside the shell of the ceiling fan-lamp, keeping its output connected with the input of the control signal-receiving unit 21 of the control circuit 20. And, the first manual pulling switch 70 and the second manual pulling switch 80 have their one end connected with the rectifying -filtering circuit 10, and another end connected with the first driving loop 23 and the second driving loop 24 respectively.

In using, a user can send a wireless control signal from the wireless emitter 611 to the wireless receiver 612, and then the signal is transmitted to the control signal receiving unit 21 and the input terminal of the microcomputer control unit 22 orderly, so as to activate the motor 40 to whirl in a controlled speed and light up the lamp 50 under a controlled brightness. In addition, instead of the wireless emitter 61, the first manual pulling switch 70 and the second manual pulling switch 80 can be respectively operated to control the motor 40 and the lamp 50.

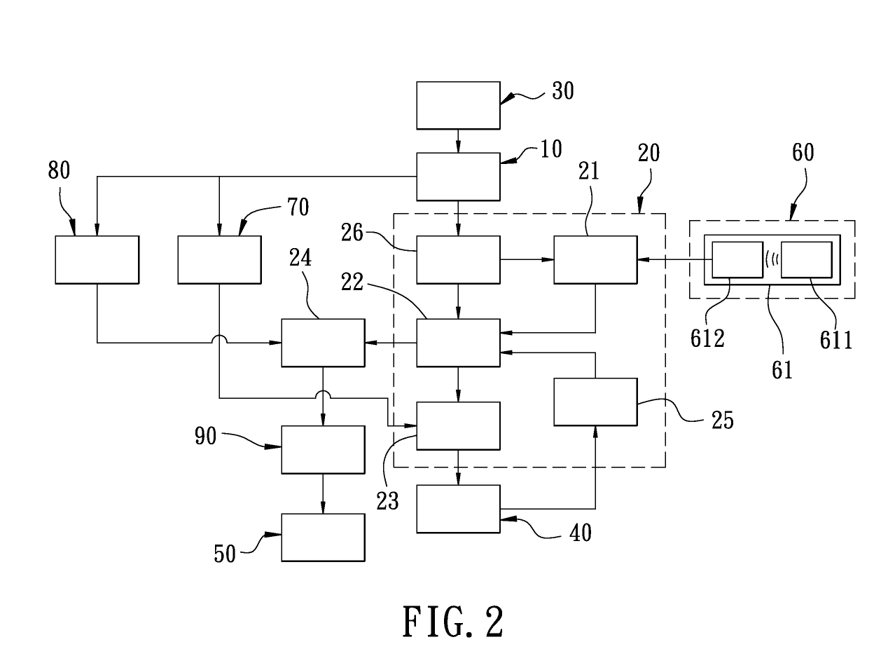

As shown in FIG. 2, a second preferred embodiment of an integrated DC circuit for a ceiling fan combined with a lamp in the present invention has the same components as the first embodiment does, except that a step-up loop 90 is installed between the lamp 50 and the second driving loop 24 if the lamp 50 is provided with PL tube lights, replaceable energy-saving tube lights or spiral tube lights, for supplying efficient voltage to activate the lamp 50.

The invention has the following advantages as can be seen from the foresaid description.

1. With the rectifying-filtering circuit 10 provided to change the exterior AC power into DC power for the motor 40 and the lamp 50 to use, the integrated DC circuit can not only be made with less material to have a simple structure so as to obtain a reduction of cost, but also effectively prevent electric leakage of the present ceiling fan-lamp.

2. The motor 40 and the lamp 50 can be controlled to work either by control signals transmitted by the control module and received by the control signal receiving unit 21 of the control circuit 20 or by pulling the first manual pulling switch 70 and the second manual pulling switch 80.

3. With the second driving loop 24 connected with the lamp 50, most of the commercial lights can be used in the lamp 50 to achieve a convenient replacement and an energy-saving effect.

While the preferred embodiment of the invention has been described above, it will be recognized and understood that various modifications may be made therein and the appended claims are intended to cover all such modifications that may fall within the spirit and scope of the invention.

What is claimed is:

1. An integrated DC circuit for a ceiling fan combined with a lamp, said DC circuit comprising:
a rectifying-filtering circuit connected with an exterior AC power source to alter the exterior AC power into DC power; and
a control circuit having its one end connected with said rectifying-filtering circuit and another end connected with a motor and a lamp respectively, said control circuit provided with a control signal receiving unit for receiving control signals transmitted by a control module set outside said lamp and a microcomputer unit employed to receive, process, analyze and code control signals transmitted from said control signal receiving unit, said microcomputer unit connected with said rectifying-filtering circuit to transmit a power to a first driving loop to activate said motor and a second driving loop to activate said lamp.

2. The integrated DC circuit for a ceiling fan combined with a lamp as claimed in claim 1, wherein said first driving loop and said second driving loop respectively receive control signals sent by a first manual pulling switch and a second manual pulling switch that are connected with said rectifying-filtering circuit.

3. The integrated DC circuit for a ceiling fan combined with a lamp as claimed in claim 1, wherein said control module is provided with a wireless control unit that is to correspond to said control signal receiving unit and provided with a wireless emitter and a wireless receiver.

4. The integrated DC circuit for a ceiling fan combined with a lamp as claimed in claim 1, wherein said motor is a DC brushless one and said microcomputer unit is connected with a Hall element for transmitting an induced signal of a detected displacement of a magnetic element provided in said DC brushless motor to said microcomputer control unit that is to process, analyze and code said signal and then transmit to said first driving loop to activate said motor to rotate in a preset speed.

5. The integrated DC circuit for a ceiling fan combined with a lamp as claimed in claim 1, wherein a power protecting unit is connected between said microcomputer unit and said rectifying-filtering circuit to prevent said control circuit from damaged by over-voltage, over-current and over-heat.

6. The integrated DC circuit for a ceiling fan combined with a lamp as claimed in claim 1, wherein said lamp is provided with LEDs.

7. The integrated DC circuit for a ceiling fan combined with a lamp as claimed in claim 1, wherein a step-up loop is connected between said second driving loop and said lamp.

8. The integrated DC circuit for a ceiling fan combined with a lamp as claimed in claim 1, wherein said lamp is provided with PL tube lights.

9. The integrated DC circuit for a ceiling fan combined with a lamp as claimed in claim 1, wherein said lamp is provided with replaceable energy-saving tube lights.

10. The integrated DC circuit for a ceiling fan combined with a lamp as claimed in claim 1, wherein said lamp is provided with spiral tube lights.
